(19) United States
(12) Patent Application Publication
(10) Pub. No.: US 2019/0196270 A1
(43) Pub. Date: Jun. 27, 2019

(54) DISPLAY DEVICE

(71) Applicant: SAKAI DISPLAY PRODUCTS CORPORATION, Sakai-shi, Osaka (JP)

(72) Inventors: MAYUMI HORI, Sakai-shi, Osaka (JP); KENICHI IWAMOTO, Sakai-shi, Osaka (JP)

(21) Appl. No.: 16/099,057

(22) PCT Filed: May 6, 2016
(86) PCT No.: PCT/JP2016/063677

§ 371 Date: Mar. 5, 2019

(51) Int. Cl. G02F 1/1335; G02B 6/02

(52) U.S. Cl. CPC G02F 1/133606; G02B 6/0229; G02F 2001/133607; G02F 1/133603; G02F 1/133611

(57) ABSTRACT

Provided is a display apparatus in which the occurrence of color nonuniformity can be prevented or reduced. A display apparatus in which light from a light source unit is transmitted through a fluorescent film before reaching a display panel, includes an optical path changing member provided between the light source unit and the fluorescent film and for changing optical path lengths within the fluorescent film of the light rays entering the fluorescent film from an incident surface of the fluorescent film.

### TECHNICAL FIELD

The present invention relates to a display apparatus in which a display panel is illuminated with light of a light source unit through a fluorescent film.

### BACKGROUND ART

Liquid crystal displays (LCDs), which are the mainstream of flat panel displays, have in recent years been widely used in the field of large-size panels for televisions, etc., as well as the field of middle- or small-size panels. In such a liquid crystal display, an optical member is disposed behind a display panel, and the display panel is illuminated with light of a light source unit through the optical member to display an image.

In the display panel, for example, a liquid crystal layer is sandwiched by two glass substrates. A color filter is formed on the inner surface of the front glass substrate, and thin film transistors (TFTs) are formed on the inner surface of the rear glass substrate. Each picture element (pixel) includes three sub-pixels having R, G, and B color filters.

A display apparatus in which a quantum dot (QD) film is employed as an example of the optical member has been disclosed (see Patent Document No. 1). The QD film is a fluorescent film containing light-emitting fine metal particles, and having the function (color conversion function) of converting excited light having a single wavelength into light having a plurality of wavelengths (blue, green, red, etc.).

### CITATION LIST

### Patent Literature

Patent Document No. 1: Japanese National Phase PCT Laid-Open Patent Publication No. 2013-544018

### SUMMARY OF INVENTION

### Technical Problem

However, in the conventional display apparatus disclosed in Patent Document No. 1, light rays from the light source unit strike the incident surface of the QD film at various angles. The light rays entering the QD film from the incident surface have different lengths of optical paths (optical path lengths) in the QD film that depend on the angle of incidence. A light ray having a greater optical path length has more chances to excite fine metal particles, resulting in a greater amount of emission of red and/or green light. Thus, light rays emitted from the light-emitting surface of the QD film have different colors due to their different optical path lengths, resulting in color nonuniformity on the light-emitting surface of the QD film.

With the above in mind, the present invention has been made. It is an object of the present invention to provide a display apparatus in which the occurrence of color nonuniformity can be prevented or reduced.

### Solution to Problem

A display apparatus according to an embodiment of the present invention in which light from a light source unit is transmitted through a fluorescent film before reaching a display panel, the display apparatus including an optical path changing member provided between the light source unit and the fluorescent film and for changing optical path lengths within the fluorescent film of light rays entering the fluorescent film from an incident surface of the fluorescent film.

### Advantageous Effects of Invention

According to the present invention, the occurrence of color nonuniformity can be prevented or reduced.

### BRIEF DESCRIPTION OF DRAWINGS

FIG. 1 is an exploded perspective view showing an example of main parts of a configuration of a display apparatus according to an embodiment of the present invention.

FIG. 2 is a schematic diagram showing a first example of a configuration of an optical member in an embodiment of the present invention.

FIG. 3 is a schematic diagram showing an example of changing of an optical path by a prism film in an embodiment of the present invention.

FIG. 4 is a schematic diagram showing as example of a configuration of a conventional optical member.

FIG. 5 is a schematic diagram showing an example of a display surface of a conventional liquid crystal display apparatus.

FIG. 6 is a schematic diagram showing an example of a display surface of a display apparatus according to an embodiment of the present invention.

FIG. 7 is a schematic diagram showing a second example of a configuration of an optical member in an embodiment of the present invention.

FIG. 8 is a schematic diagram showing a third example of a configuration of an optical path changing member in an embodiment of the present invention.

FIG. 9 is a schematic diagram showing a fourth example of a configuration of an optical path changing member in an embodiment of the present invention.

FIG. 10 is a schematic diagram showing a fifth example of a configuration of an optical path changing member in an embodiment of the present invention.

FIG. 11 is a schematic diagram showing a sixth example of a configuration of an optical path changing member in an embodiment of the present invention.

FIG. 12 is an explanatory diagram showing an example of evaluation data of color nonuniformity in the case of an optical path changing member in an embodiment of the present invention.

FIG. 13 is an explanatory diagram showing evaluation data of luminance in the case of an optical path changing member in an embodiment of the present invention.

FIG. 14 is an explanatory diagram showing an example of evaluation data of chromaticity (y-coordinate) in the case of an optical path changing member in an embodiment of the present invention.

### DESCRIPTION OF EMBODIMENTS

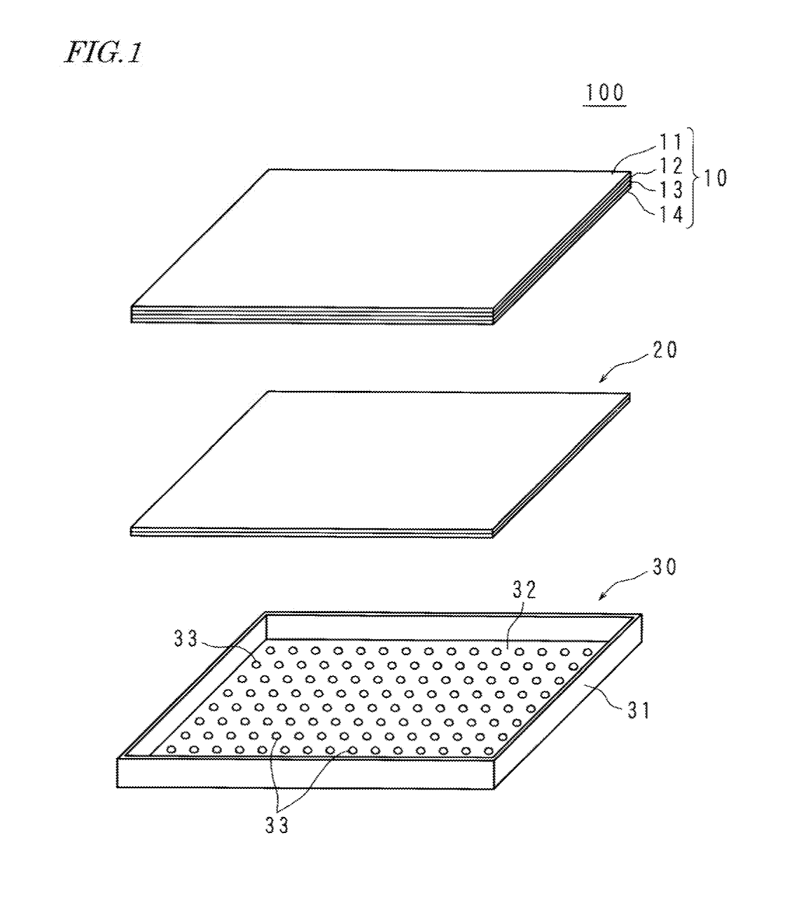

The present invention will now be described with reference to the accompanying drawings showing embodiments thereof. FIG. 1 is an exploded perspective view showing an example of main parts of a configuration of a apparatus 100 according to an embodiment of the present invention. As shown in FIG. 1, the display apparatus 100 includes a liquid crystal panel 10 as a panel for displaying an image (including a video), a backlight unit 30 that is provided behind the liquid crystal panel 10 and illuminates the liquid crystal panel 10 with light required to display an image, etc. Note that, in FIG. 1, members of the display apparatus 100, such as an outer frame for covering the liquid crystal panel 10, are not shown for the same of convenience. Regarding terminology concerning directions as used herein, “front” refers to the direction in which the display apparatus 100 displays an image; the opposite direction of thereof is referred to as “rear”.

The liquid crystal panel 10 includes a liquid crystal layer (not shown), a light-transmissive front substrate 12 and rear substrate 13 that sandwich the liquid crystal layer, a pair of polarizing plates 11 and 14 that are provided on outer surfaces of the front substrate 12 and the rear substrate 13, respectively, etc. A color filter is formed on an inner surface of the front substrate 12, and each picture element (pixel) includes three sub-pixels having R, G, and B color filters. Data lines and scan lines are arranged in a matrix, extending in vertical and horizontal directions, on an inner surface of the rear substrate 13. A thin film transistor (TFT) is provided at each of intersections between the data lines and the scan lines. A drive circuit that drives the data lines and the scan lines is formed in a peripheral region of the rear substrate 13. The amount of light transmitted through the pair of polarizing plates 11 and 14 is controlled on a pixel-by-pixel basis by illuminating the liquid crystal panel 10 with light from LEDs 33 (described below) provided in the backlight unit 30, and modulating the polarized state of the illumination light using the liquid crystal layer, whereby a predetermined image can be displayed. The two substrates included in the liquid crystal panel 10 that are located on the front side and the rear side are herein referred to as a “front substrate” and a “rear substrate,” respectively.

The backlight unit 30 (light source unit) includes a box-shaped chassis 31 having an opening on the front side thereof, a substrate 32 fixed to a bottom plate of the chassis 31, a plurality of LEDs (light source units) 33 mounted on the substrate 32 and arranged in a grid pattern with a predetermined space between each LED, etc. The arrangement of the plurality of LEDs 33 is not particularly limited if it is a grid pattern. The plurality of LEDs 33 may be arranged not only in the so-called matrix (i.e., in vertical and horizontal directions), but also in the so-called staggered arrangement. In addition, the arrangement (the direction and pitch of aligned LEDs 33) of LEDs 33 provided in a peripheral region of the substrate 32 may be slightly different from the arrangement of LEDs 33 in a central region of the substrate 32.

The optical member 20 is disposed at the opening of the chassis 31, facing the substrate 32. The optical member 20, which is, for example, formed of a plurality of optical films stacked together, homogenizes light from the plurality of LEDs 33. The optical member 20 is described in detail below.

The LED 33 includes a blue LED and a secondary lens provided to cover the blue LED. Light emitted from the blue LED is diffused by the secondary lens.

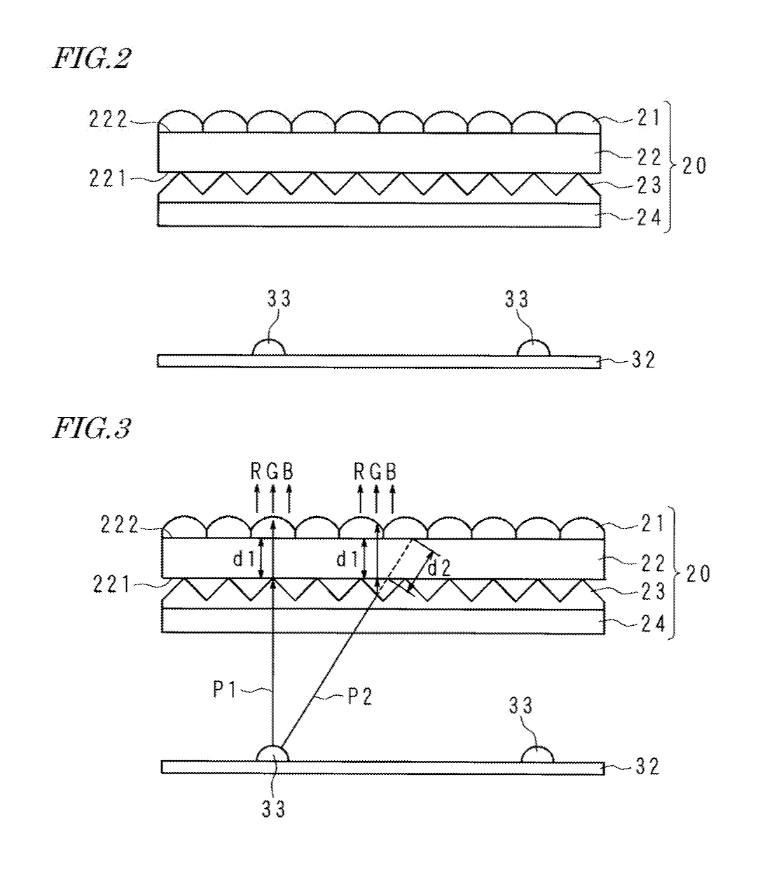

FIG. 2 is a schematic diagram showing a first example of a configuration of the optical member 20 in an embodiment of the present invention. As shown in FIG. 2, the optical member 20 and the substrate 32 on which the plurality of LEDs 33 are mounted are spaced a predetermined distance apart. The optical member 20 includes a light condensing member 21 whose surface closer to the liquid crystal panel 10 has an uneven curved shape, a fluorescent film 22, a prism film 23 as a first example of the optical path changing member, and a diffusion plate 24 having a surface on which minute recesses and protrusions are provided, which are successively stacked in that order with the light condensing member 21 closest to the liquid crystal panel 10. The prism film 23 has, on a front surface thereof, a plurality of grooves that are formed so as to form a plurality of ridges extending in the same direction. A cross-section of the plurality of ridges that is perpendicular to that direction (also referred to as a “groove direction”) has a shape that a plurality of isosceles triangles are linked together with their bases aligned. In an embodiment of the present invention, the prism film 23 is disposed such that the ridges are located close to the fluorescent film 22.

Thus, the prism film 23 is disposed between the fluorescent film 22 and the LEDs 33. The fluorescent film 22 has an incident surface 221 and a light-emitting surface 222. Although FIG. 2 illustrates that the members (the light condensing member 21, the fluorescent film 22, the prism film 23, and the diffusion plate 24) constituting the optical member 20 are tightly attached together, a feature of the present embodiment is achieved by the presence of an air layer having such a thickness that the layer cannot be depicted, between each member.

The fluorescent film 22 contains light-emitting fine metal particles that are excited to generate red and/or green light when blue light from the LEDs 33 travels within the fluorescent film 22. Thus, in the objective perspective, the fluorescent film 22 is considered to have the function of converting a portion of blue light entering thereinto into red and/or green light, and emitting out the red and/or green light (color conversion function). Blue light having a greater optical path length (also referred to as the “length of an optical path”) within the fluorescent film 22 has more chances to excite light-emitting fine metal particles, so that fine metal particles convert the blue light into a greater amount of red and/or green light. A combination of the fluorescent film 22 with a color filter can generate color components (red, green, and blue) for providing white.

FIG. 3 is a schematic diagram showing an example of changing of an optical path by the prism film 23 in the present embodiment. Although light emitted from the LED 33 is diffused, FIG. 3 shows light P1 that is emitted in a direction perpendicular to the incident surface 221 of the fluorescent film 22, and light P2 that is emitted in a direction oblique to the incident surface 221 of the fluorescent film 22, for the sake of convenience and for ease of understanding of changing of an optical path.

As shown in FIG. 3, the blue light P1 from the LED 33 perpendicularly strikes the incident surface 221 of the fluorescent film 22. The light P1, which is blue light, enters the fluorescent film 22 from the incident surface 221, and in the objective perspective, when traveling within the fluorescent film 22, is partially converted into red light and/or green light by light-emitting fine metal particles in the fluorescent film 22. In this case, the optical path length of the light P1 within the fluorescent film 22 is equal to the thickness of the fluorescent film 22 (the distance between the incident surface 221 and the light-emitting surface 222: reference sign d1 in FIG. 3). The light P1 is emitted, as white light that is a suitable combination of red (R), green (G), and blue (B) spectra, from the light condensing member 21 toward the liquid crystal panel 10.

Meanwhile, the optical path of the blue light P2 from the LED 33 is changed by the prism film 23 before arriving at the incident surface 221 of the fluorescent film 22. Specifically, the prism film 23 changes the optical path of the light P2 that would otherwise obliquely strike the incident surface 221 such that the light P2 perpendicularly strikes the incident surface 221 of the fluorescent film 22. After the optical path is changed, the blue light P2 enters the fluorescent film 22, and in the objective perspective, when traveling within the fluorescent film 22, is partially converted into red light and/or green light by light-emitting fine metal particles in the fluorescent film 22. In this case, the optical path length of the light P2 within the fluorescent film 22 is equal to the thickness (reference sign d1 in FIG. 3) of the fluorescent film 22. As with the light P1, the light P2 is emitted, as white light that is a suitable combination of red (R), green (G), and blue (B) spectra, from the light condensing member 21 toward the liquid crystal panel 10. Note that light outgoing from the light condensing member 21 toward the liquid crystal panel 10 diffuses or spreads over a certain wide area, which is however indicated by arrows R, G, and B in FIG. 3 for the sake of convenience.

In the case where the prism film 23 is not provided, the light P2 enters the fluorescent film 22 from the incident surface 221 of the fluorescent film 22 without changing the optical path along a direction oblique to the incident surface 221 as indicated by a dashed line in FIG. 3, and therefore, the optical path length (length indicated by reference sign d2 in FIG. 3) of the light P2 within the fluorescent film 22 is greater than d1 (d1<d2).

As described above, the prism film 23 changes the optical path lengths within the fluorescent film 22 of light rays that enter the fluorescent film 22 from the incident surface 221. Specifically, the prism film 23 changes the optical paths of light rays from the LED 33 and thereby changes the angles of incidence of the light rays to the incident surface 221 of the fluorescent film 22 before the light rays arrive at the incident surface 221 of the fluorescent film 22, so as to change the optical path lengths within the fluorescent film 22 of light rays (e.g., the light P2 in FIG. 3) entering the fluorescent film 22 from the incident surface 221.

The prism film 23 can change the optical path lengths within the fluorescent film 22, and therefore, can change the conversion amount of light, so that color nonuniformity on the light-emitting surface 222 of the fluorescent film 22 can be prevented or reduced. Note that the conversion amount of light refers to the amount of light whose wavelength is converted by the color conversion function of the fluorescent film 22 (e.g., the amount of a portion of blue light emitted from the LED 33 that is converted into red light and/or green light).

The prism film 23 also changes the optical paths of light rays (e.g., the light P1 and P2 in FIG. 3) traveling toward the incident surface 221 of the fluorescent film 22 at different angles with respect to the incident surface 221 before the light rays arrive at the incident surface 221 so as to reduce the differences in optical path lengths within the fluorescent film 22 among the light rays traveling after entering the fluorescent film 22. Specifically, the prism film 23 changes the optical paths of light rays from the LED 33 and thereby changes the angles of incidence of the light rays to the incident surface 221 of the fluorescent film 22 before the light rays arrive at the incident surface 221 of the fluorescent film 22 so as to reduce the differences in optical path lengths within the fluorescent film 22 among the light rays traveling within the fluorescent film 22.

The prism film 23 can reduce the differences in optical path lengths within the fluorescent film 22 among light rays traveling within the fluorescent film 22, and therefore, can reduce the differences in conversion amounts among the light rays within the fluorescent film 22, so that color nonuniformity on the light-emitting surface 222 of the fluorescent film 22 can be prevented or reduced.

The prism film 23 also changes the optical paths of light rays before the light rays arrive at the incident surface 221 so as to reduce the differences in optical path lengths within the fluorescent film 22 between the light rays emitted from the LED 33 in a direction oblique to the incident surface 221 of the fluorescent film 22 and a light ray emitted from the LED 33 in a direction perpendicular to the incident surface 221 of the fluorescent film 22. As a result, the differences in optical path lengths within the fluorescent film 22 among light rays are reduced, so that the differences in conversion amounts in the fluorescent film 22 among the light rays can be reduced, and therefore, color nonuniformity on the light-emitting surface 222 of the fluorescent film 22 can be prevented or reduced. Although FIGS. 2 and 3 show the optical member 20 including the four members, i.e., the light condensing member 21, the fluorescent film 22, the prism film 23, and the diffusion plate 24, an additional sheet may be provided on top of the light condensing member 21 in order to prevent or reduce luminance nonuniformity on the front surface of the optical member 20. Specifically, a diffusion sheet for reducing the degree of light condensation by the light condensing member 21, a light condensing sheet for further enhancing the degree of light condensation by the light condensing member 21, a reflection sheet, a polarization sheet, etc., may be provided on top of the light condensing member 21.

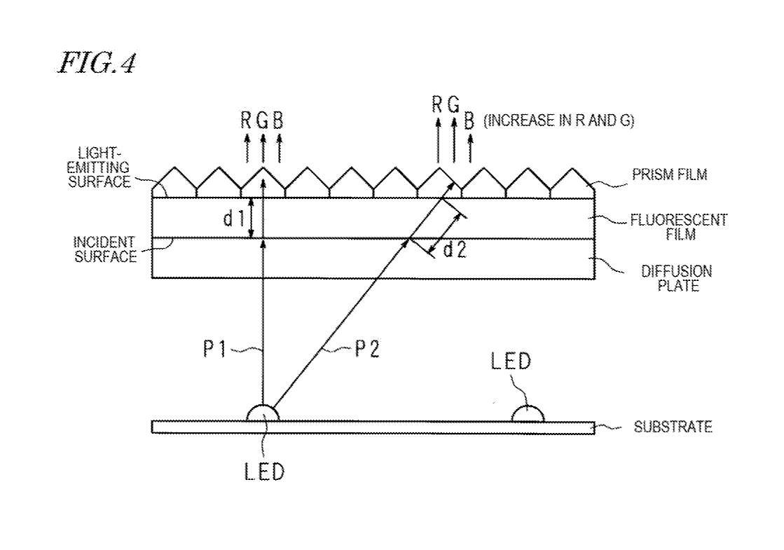

FIG. 4 is a schematic diagram showing an example of a configuration of a conventional optical member. As shown in FIG. 4, the conventional optical member includes a prism film having ridges formed on a surface thereof closer to a liquid crystal panel, a fluorescent film, and a diffusion plate having minute recesses and protrusions on a surface thereof, with the prism film closest to the liquid crystal panel.

As shown in FIG. 4, the blue light P1 from LEDs perpendicularly strikes the incident surface of the fluorescent film. The light P1, which is blue light, enters the fluorescent film from the incident surface, and in the objective perspective, when traveling within the fluorescent film, is partially converted into red light and/or green light by light-emitting fine metal particles in the fluorescent film. In this case, the optical path length of the light P1 within the fluorescent film is equal to the thickness of the fluorescent film 22 (reference sign d1 in FIG. 4). The light P1 is emitted, as white light that is a suitable combination of red (R), green (G), and blue (B) spectra, from the prism film toward the liquid crystal panel.

Meanwhile, blue light P2 from LEDs enters the fluorescent film from the incident surface of the fluorescent film without changing the optical path along a direction oblique to the incident surface. Therefore, the optical path length of the light P2 within the fluorescent film (length indicated by reference sign d2 in FIG. 4) is greater than the optical path length d1 of the light P1. As described above, as the optical path lengths within the fluorescent film increase, the conversion amount of light that is converted into red light and/or green light by light-emitting fine metal particles increases, so that more red (R) and green (G) light components are emitted from the light-emitting surface of the fluorescent film, leading to an imbalance between red (R), green (G), and blue (B) spectra, which is unsuitable for generation of white light.

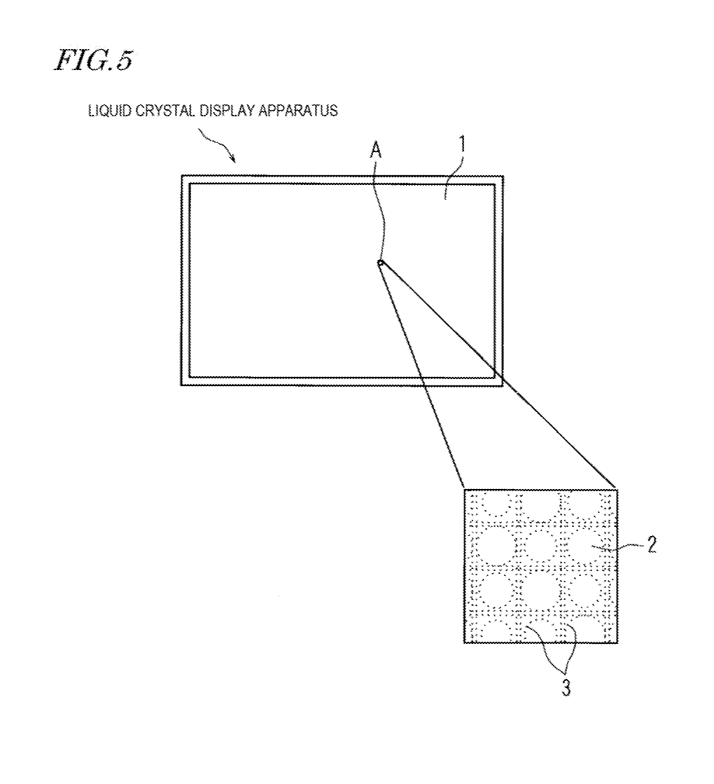

FIG. 5 is a schematic diagram showing an example of a display surface 1 of a conventional liquid crystal display apparatus. FIG. 5 shows an enlarged view of a small region A of the display surface 1. The small region A is, for example, a square with a side of several pitches of LEDs of the backlight device. As shown in FIG. 5, color nonuniformity occurs due to the appearance of regions 2 and regions 3. The region 2 is located directly in front of the LED, and has a relatively low chromaticity in the CIE chromaticity diagram, i.e., exhibits the so-called “blue.” The region 3 surrounds the region located directly in front of the LED, and has a relatively high chromaticity, i.e., exhibits the so-called “yellow.” Such a region 2 and region 3 appear at the pitch of LEDs, and therefore, the conventional liquid crystal display apparatus as shown in FIG. 5 does not have good display quality. Although, in FIG. 5, two different regions indicate two different chromaticities for the sake of convenience, the actual chromaticity continuously changes over the regions.

In contrast, in an embodiment of the present invention, the prism film 23 changes the optical paths of light rays that will enter the fluorescent film 22 from the incident surface 221 so as to reduce the optical path lengths of the light rays within the fluorescent film 22. Specifically, in the present embodiment, the optical path lengths within the fluorescent film 22 of light rays emitted from the LED 33 in a direction oblique to the incident surface 221 of the fluorescent film 22 can be made closer the optical path lengths within the fluorescent film 22 of light rays emitted from the LED 33 in a direction perpendicular to the incident surface 221.

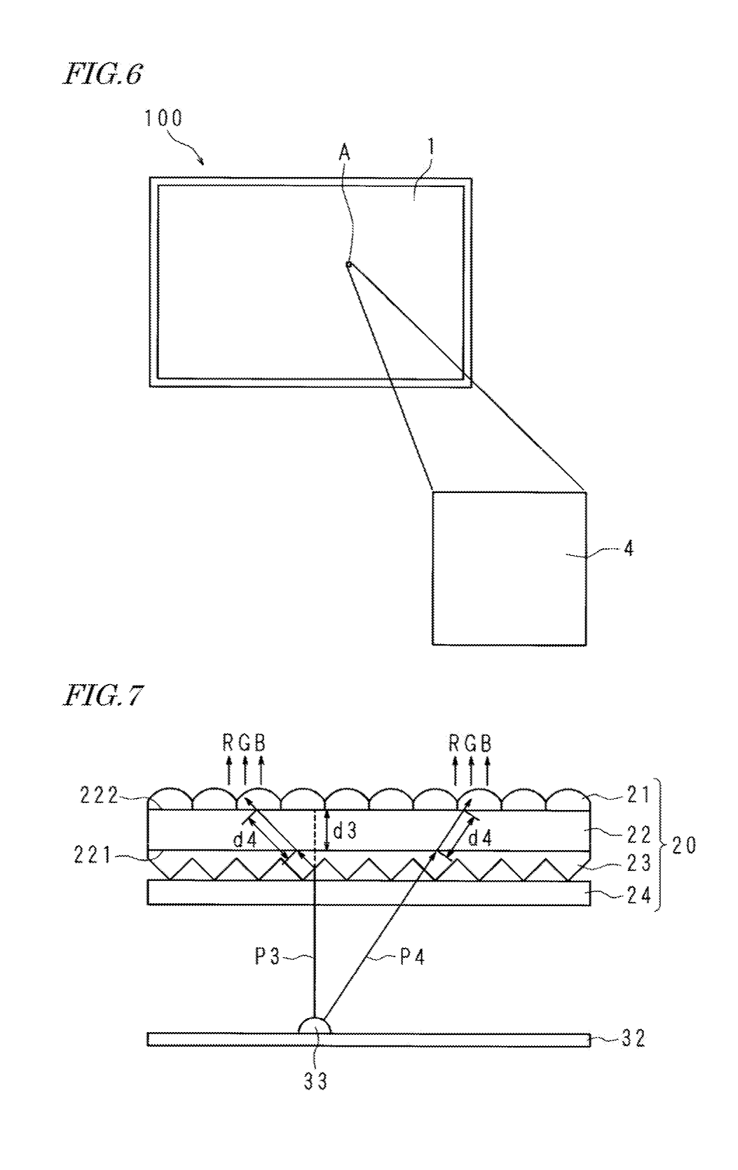

FIG. 6 is a schematic diagram showing an example of the display surface 1 of the display apparatus 100 of the present embodiment. FIG. 6 shows an enlarged view of a small region A of the display surface 1. The small region A is, for example, a square with a side of several pitches of LEDs of the backlight device 30. As described above, in the present embodiment, the conversion amount in the fluorescent film 22 of light emitted from the LED 33 in a direction oblique to the incident surface 221 of the fluorescent film 22 can be reduced, and therefore, the amount of red and/or green components of light emitted from a region of the light-emitting surface 222 of the fluorescent film 22 that surrounds the region located directly in front of the LED 33 reduced, so that the degree of balance between the components of the light can be made closer the degree of balance between the components of light emitted from the region located directly in front of the LED 33. As a result, variations in chromaticity in the small region A can be reduced, resulting in a region 4 having substantially uniform chromaticity. Thus, the occurrence of color nonuniformity can be prevented or reduced.

FIG. 7 is a schematic diagram showing a second example of a configuration of the optical member 20 in the present embodiment. The configuration of FIG. 7 is different from that of FIG. 2 in that the prism film 23 is disposed such that the ridges are located closer to the diffusion plate 24. In other words, compared to the case shown in FIG. 2, the prism film 23 is turned upside down, i.e., with the front surface at the bottom, and the rear surface at the top. The prism film 23 as the second example of the optical path changing member in which the ridges are located closer to the diffusion plate 24 as shown in FIG. 7 is referred to as an “inverted prism.”

FIG. 7 also schematically shows an example of changing of an optical path by the prism film 23 in the present embodiment. Although light emitted from the LED 33 is diffused, FIG. 7 illustrates light P3 emitted from the LED 33 in a direction perpendicular to the incident surface 221 of the fluorescent film 22, and light P4 emitted from the LED 33 in a direction oblique to the incident surface 221 of the fluorescent film 22, for the sake of convenience and for ease of understanding of a change in optical path.

As shown in FIG. 7, the blue light P4 from the LED 33 obliquely strikes the incident surface 221 of the fluorescent film 22. The optical path length within the fluorescent film 22 of the light P4 entering the fluorescent film 22 from the incident surface 221 is represented by d4.

In contrast, the optical path of the blue light P3 from the LED 33 is changed by the prism film 23 before the light P3 arrives at the incident surface 221 of the fluorescent film 22, and then obliquely strikes the incident surface 221 of the fluorescent film 22. The optical path length within the fluorescent film 22 of the blue light P3 from the LED 33 that would otherwise perpendicularly strike the incident surface 221 of the fluorescent film 22 without changing the optical path is represented by d3. The optical path length d3 is equal to the thickness of the fluorescent film 22. When the light P3 enters the fluorescent film 22 from the incident surface 221 of the fluorescent film 22 after the optical path thereof is changed by the prism film 23, the optical path length within the fluorescent film 22 is greater than d3 and is closer to the optical path length of the blue light P4 (in FIG. 7, the optical path length of the light P3 is represented by reference sign d4).

As described above, the prism film 23 changes the optical paths of light rays emitted from the LED 33 in a direction perpendicular to the incident surface 221 of the fluorescent film 22 so as to increase the optical path lengths of the light rays within the fluorescent film 22. Specifically, the prism film 23 changes the optical paths of light rays traveling from the LED 33 in a direction perpendicular to the incident surface 221 of the fluorescent film 22 (the light P3 of FIG. 7) before the light rays enter the fluorescent film 22, so as to increase the optical path lengths within the fluorescent film 22 of the light rays entering the incident surface 221 of the fluorescent film 22. Thus, the optical path lengths within the fluorescent film 22 of light rays traveling in a direction perpendicular to the incident surface 221 can be changed to be closer to the optical path lengths within the fluorescent film 22 of light rays emitted from the LED 33 in a direction oblique to the incident surface 221 (the light P4 of FIG. 7).

As a result, the amount of light rays perpendicularly entering the incident surface 221 and then traveling within the fluorescent film 22 is reduced, and therefore, the amount of a blue component of light emitted from a region of the light-emitting surface 222 of the fluorescent film 22 located directly in front of the LED 33 can be reduced.

In addition, the optical paths of light rays traveling in a direction perpendicular to the incident surface 221 are changed so as to increase the optical path lengths within the fluorescent film 22 of the light rays entering from the incident surface 221, and therefore, the conversion amount of the light within the fluorescent film 22 is increased. As a result, the amounts of a red component and/or a green component of light emitted from a region of the light-emitting surface 222 of the fluorescent film 22 surrounding the region located directly in front of the LED 33 can be increased, and therefore, color nonuniformity can be prevented or reduced on the light-emitting surface of the fluorescent film 22.

In the above embodiment, the prism film as a first example of the optical path changing member, and the prism film (inverted prism) that is turned upside down, i.e., with the front surface at the bottom, and the rear surface at the top, as a second example of the optical path changing member, have been described. The optical path changing member is not limited to these examples. Other examples of the optical path changing member will now be described.

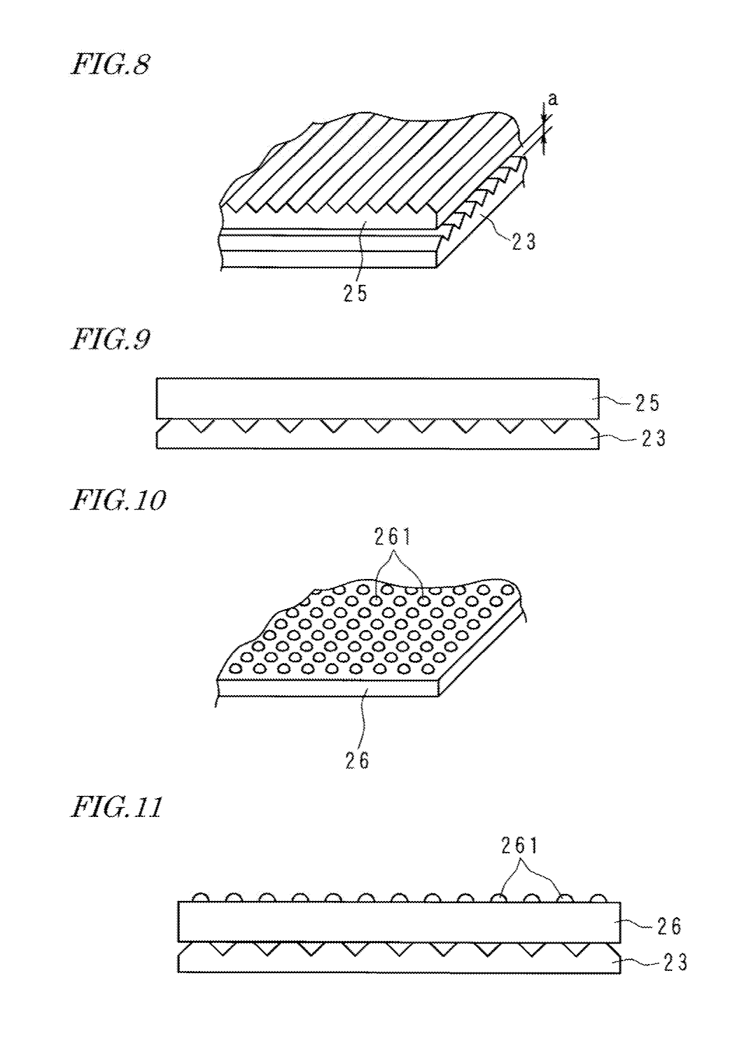

FIG. 8 is a schematic diagram showing a third example of a configuration of the optical path changing member in the present embodiment. In the example of FIG. 8, an optical path changing member includes two prism films 23 and 25. Specifically, as shown in FIG. 8, the prism film 23 and the prism film 25 are disposed so that the ridges of the prism film 23 and the ridges of the prism film 25 intersect at right angles. The two prism films 23 and 25 exhibit the desired effect due to the presence of an air layer therebetween. Specifically, as shown in FIG. 8, a distance a between the apex of the ridge of the prism film 23 and the rear surface of the prism film 25 is not zero. The two prism films 23 and 25 are also referred to a “double prism film.”

FIG. 9 is a schematic diagram showing a fourth example of a configuration of the optical path changing member in the present embodiment. In the example of FIG. 9, two prism films 23 and 25 are integrally formed. Specifically, as shown in FIG. 9, the ridges of the rear prism film 23 are continuous to the front prism film 25 with the apexes of ridges crushed. The two prism films integrally formed are also referred to as a “composite film 1 (prism-on-prism)”. Only one of the prism film 23 and the prism film 25 is referred to as a “prism film.”

FIG. 10 is a schematic diagram showing a fifth example of a configuration of the optical path changing member in the present embodiment. A microlens film 26 shown in FIG. 10 includes microlenses 261 arranged in a grid pattern on a surface of a substrate.

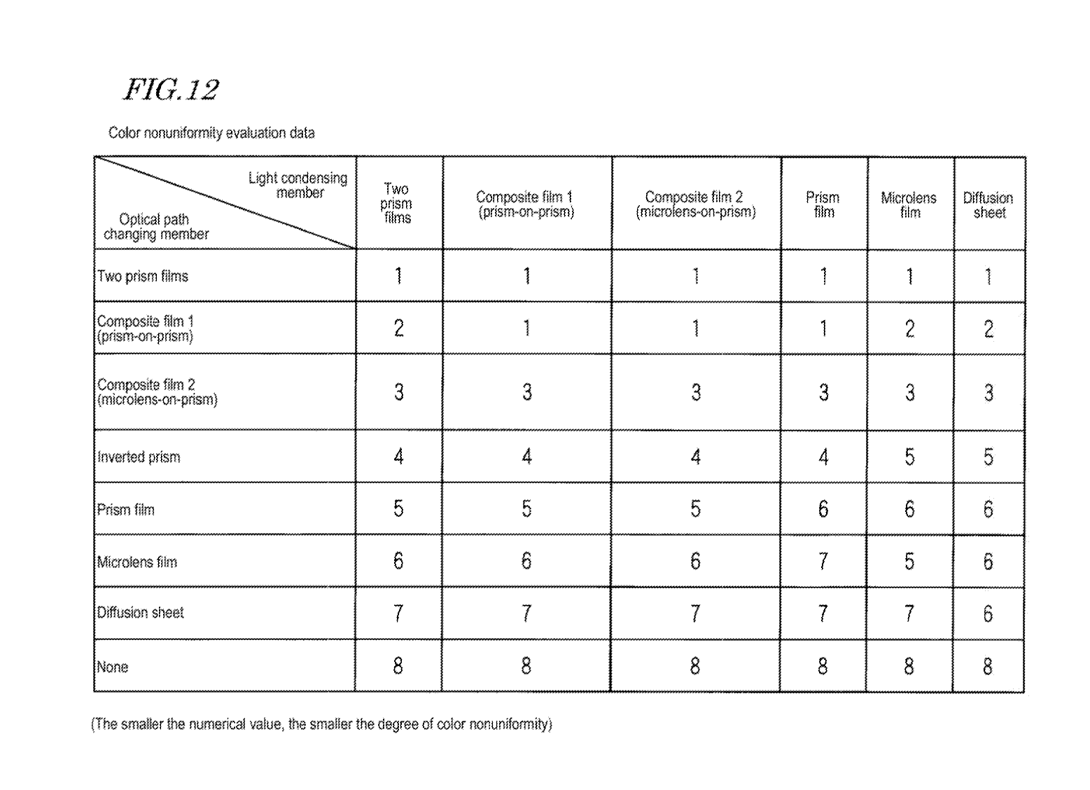

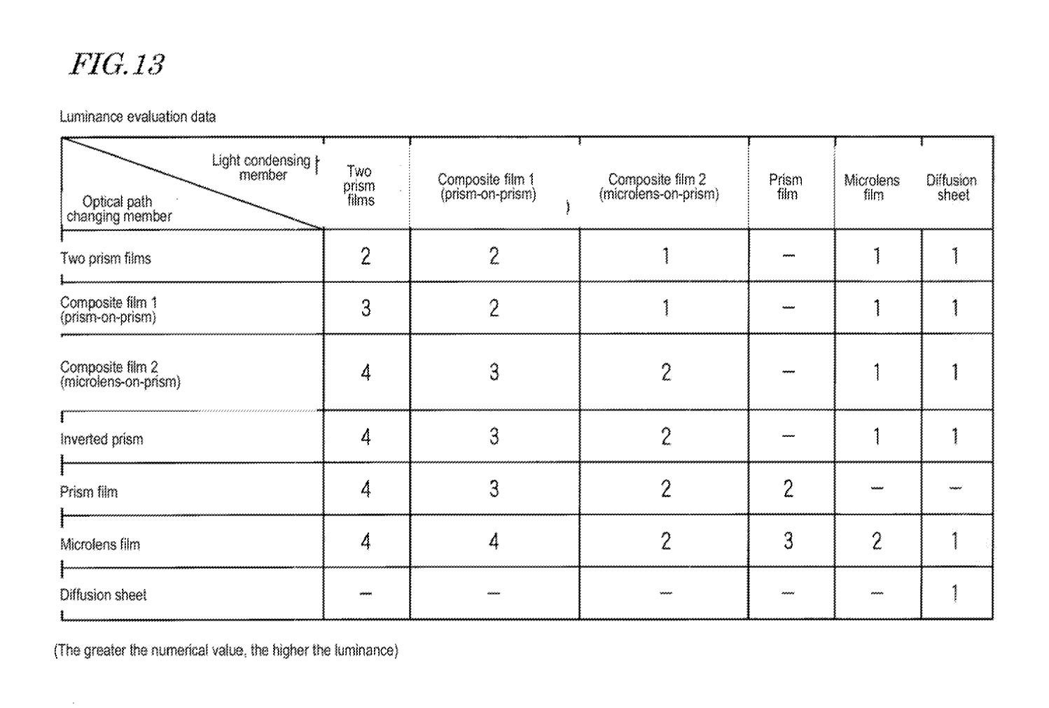

FIG. 11 is a schematic diagram showing a sixth example of a configuration of the optical path changing member in the present embodiment. The optical path changing member of FIG. 11 is referred to as a “composite film 2 (microlens-on-prism)”. As with the above composite film 1 (prism-on-prism), the composite film 2 (microlens-on-prism) includes a prism film 23 and a microlens film 26 that are integrally formed without an interstice therebetween. In the composite film 2, the ridges of the rear prism film 23 are continuous to the front microlens prism film 25 with the apexes of ridges crushed.

FIG. 12 is an explanatory diagram showing an example of evaluation data of color nonuniformity in the case of the optical path changing member in the present embodiment. FIG. 12 shows color nonuniformity that occurred when the two prism films, the composite film 1 (prism-on-prism), the composite film 2 (microlens-on-prism), the inverted prism, the prism film, and the microlens film were used as the optical path changing member, and the two prism films, the composite film 1 (prism-on-prism), the composite film 2 (microlens-on-prism), the prism film, and the microlens film were used as the light condensing member (a member provided on a surface closer of the fluorescent film 22 to the liquid crystal panel 10, using a scale of one to eight. A smaller numerical value of the rating indicates a greater amelioration of color nonuniformity. Note that FIG. 12 also shows ratings of conventional configurations including a diffusion sheet. Note that color nonuniformity can be evaluated by detecting light emitted out from the light condensing member.

As shown in FIG. 12, for example, in the case where the two prism films were used as the optical path changing member, the rating was one irrespective of the type of the light condensing member. In the case where the prism film was used as the optical path changing member, the ratings were 5 and 6. Note that in the case where no optical path changing member was used as a conventional example, the rating was eight irrespective of the type of the light condensing member. As can be seen from FIG. 12, color nonuniformity is ameliorated in the case where the two prism films, the composite film 1 (prism-on-prism), the composite film 2 (microlens-on-prism), the inverted prism, the prism film, the microlens film, and the diffusion sheet were used as the optical path changing member, compared to the conventional cases. Note that it may be determined, as appropriate, which of the prism films, the composite film 1 (prism-on-prism), the composite film 2 (microlens-on-prism), the inverted prism, the prism film, the microlens film, and the diffusion sheet should be used as the optical path changing member, depending on the size or type of the liquid crystal panel 10, the pitch of the LEDs 33 of the backlight unit 30, the distance between the LEDs 33 and the optical member 20, the desired display quality level, etc. Note, that, as shown in FIG. 12, color nonuniformity can be further ameliorated using the inverted prism instead of the prism film. It is not easily foreseeable that a more excellent effect can be obtained on the basis of such a difference in configuration.

FIG. 13 is an explanatory diagram showing evaluation data of luminance in the case of the optical path changing member in the present embodiment. The same optical path changing members and light condensing members as those of FIG. 12 were used. The levels of the luminance were evaluated using a scale of one to four. A greater numerical value of the rating indicates a higher luminance.

As shown in FIG. 13, for example, in the case where the two prism films were used as the light condensing member, and the composite film 2 (microlens-on-prism), the inverted prism, the prism film, the microlens film, and the diffusion sheet were used as the optical path changing member, the ratings were four, which indicates the highest luminance. In the case where the composite film 1 (prism-on-prism) was used as the light condensing member, and the microlens film was used as the optical path changing member, the rating was also four, which indicates the highest luminance. As can be seen from FIG. 13, the luminance tends to increase in the case where the two prism films are selected as the light condensing member, compared to the microlens film, or in the case where the two prism films are selected as the optical path changing member, compared to the microlens film. In other words, the luminance tends to increase as one proceeds leftward in the diagram, and as one proceeds downward in the diagram. It may be determined, as appropriate, which of the members should be used as the light condensing member or the optical path changing member, depending on the predetermined luminance.

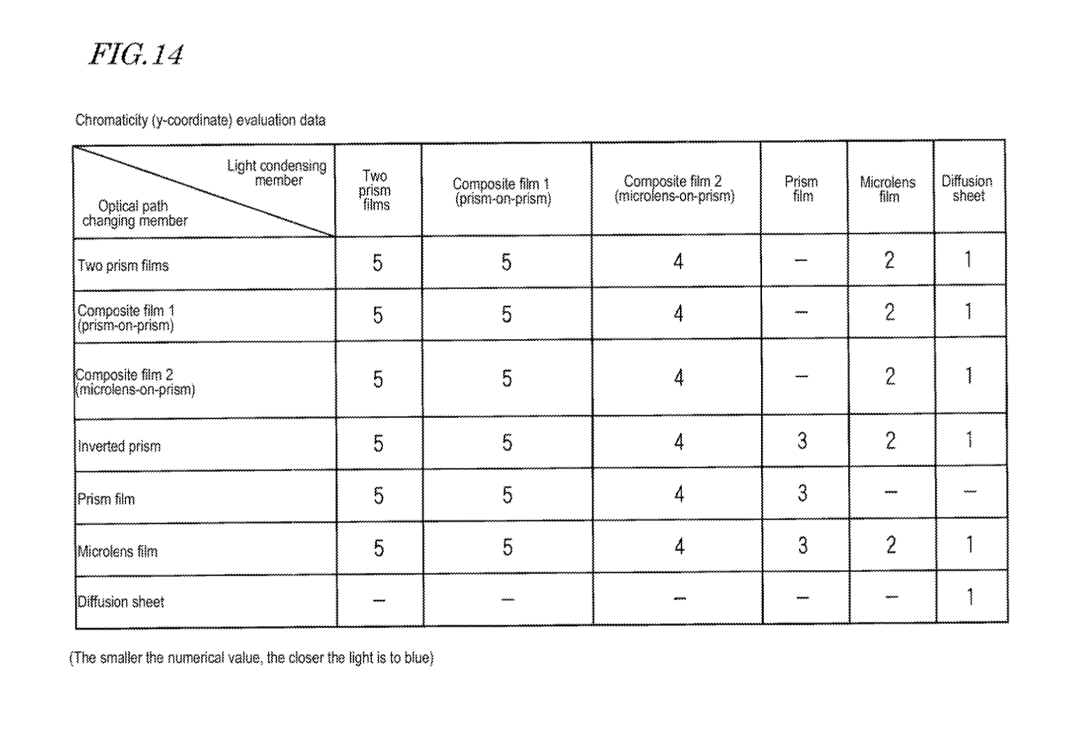

FIG. 14 is an explanatory diagram showing an example of evaluation data of chromaticity (y-coordinate) in the case of the optical path changing member in the present embodiment. The same optical path changing members and light condensing members as those of FIGS. 12 and 13 were used. The level of the chromaticity y is evaluated using a scale of one to five. A greater numerical value of the rating indicates a greater chromaticity y. Specifically, the chromaticity y becomes closer to yellow as the numerical value of the rating increases, and closer to blue as the numerical value of the rating decreases. As shown in FIG. 14, the chromaticity y tends to be substantially independent of the type of the optical path changing member. The chromaticity y also tends to increase and be closer to yellow in the case where the two prism films are used as the light condensing member (i.e., a light condensing member closer to the left end in FIG. 14), compared to the microlens film. It may be determined, as appropriate, which of the members should be used as the light condensing member, depending on the predetermined chromaticity y. The rating of the chromaticity y tends to be independent of which of the members is used as the optical path changing member.

In the present embodiment, the case where the so-called direct-lit backlight is used has been described. Alternatively, in the present embodiment, an edge-lit backlight can be used.

In the display apparatus of the present embodiment, light from the light source unit is transmitted through the fluorescent film before reaching the display panel, and an optical path changing member that changes the optical path length within the fluorescent film of light entering the fluorescent film from the incident surface is provided between the light source unit and the fluorescent film.

The optical paths of light rays from the light source unit are changed by the optical path changing member before the light rays arrives at the incident surface of the fluorescent film. As a result, the angles of incidence to the incident surface of the fluorescent film are changed, so that the optical path lengths within the fluorescent film of the light rays entering from the incident surface are changed.

By providing the optical path changing member, the optical path lengths within the fluorescent film can be changed. For example, the optical paths of light rays entering the fluorescent film from the incident surface can be changed, so that the optical path lengths within the fluorescent film can be changed, and therefore, the conversion amount of light (e.g., the amount of a portion of blue light emitted from the light source unit that is converted into red and/or green light) can be changed. As a result, color nonuniformity on the light-emitting surface of the fluorescent film can be prevented or reduced.

In the display apparatus of the present embodiment, the optical path changing member changes the optical paths of light rays traveling toward the incident surface at different angles with respect to the incident surface such that the differences in optical path lengths within the fluorescent film among the light rays traveling after entering the fluorescent film are reduced.

The optical path changing member changes the optical paths of light rays from the light source unit that travels toward the incident surface of the fluorescent film at different angles with respect to the incident surface, before the light rays enter the fluorescent film, and thereby changes the angles of incidence of the light rays to the incident surface of the fluorescent film, such that the differences in optical path lengths within the fluorescent film among the light rays entering the fluorescent film are reduced.

The optical path changing member can reduce the differences in optical path lengths within the fluorescent film among light rays traveling toward the incident surface of the fluorescent film at different angles with respect to the incident surface, and thereby reduce the differences in conversion amounts within the fluorescent film among the light rays. As a result, color nonuniformity on the light-emitting surface of the fluorescent film can be prevented or reduced.

In the display apparatus of the present embodiment, the light source unit includes a substrate disposed to face the fluorescent film, and a plurality of LEDs (light sources) disposed on the substrate. A diffusion member that diffuses light rays from the light source unit is provided between the substrate and the fluorescent film. The optical path changing member is disposed between the fluorescent film and the diffusion member.

Light rays from the LEDs disposed on the substrate is transmitted through the diffusion member, and thereafter, the optical paths of light rays are changed by the optical path changing member. The changes in optical paths by the optical path changing member results in changes in the angles of incidence to the incident surface of the fluorescent film, so that the optical path lengths within the fluorescent film of the light rays entering the fluorescent film can be changed.

In the display apparatus of the present embodiment, the optical path changing member changes the optical paths so as to reduce the differences in optical path lengths within the fluorescent film among light rays emitted from the LED in a direction oblique to the incident surface and light rays emitted from the LED in a direction perpendicular to the incident surface.

For example, the optical path changing member changes the optical paths of light rays from the light source unit before the light rays arrive at the incident surface of the fluorescent film, so as to reduce the differences in angles of incidence to the incident surface of the fluorescent film among the light rays from the LEDs on the substrate. As a result, the differences in optical path lengths within the fluorescent film among light rays entering the fluorescent film can be reduced, resulting in a reduction in the differences in conversion amounts of light. Therefore, color nonuniformity on the light-emitting surface of the fluorescent film can be prevented or reduced.

In the display apparatus of the present embodiment, the optical path changing member changes the optical paths of light rays emitted from the LED in a direction oblique to the incident surface so as to reduce the optical path lengths of the light rays within the fluorescent film.

The optical path changing member changes the optical paths of light rays emitted from the LED in a direction oblique to the incident surface of the fluorescent film before the light ray enter the fluorescent film, so as to reduce the optical path lengths of the light rays within the fluorescent film. Specifically, the optical path lengths within the fluorescent film of light rays emitted from the LED in a direction oblique to the incident surface are changed to be closer to the optical path lengths within the fluorescent film of light rays emitted from the LED in a direction perpendicular to the incident surface. As a result, the conversion amounts within the fluorescent film of light rays emitted from the LED in a direction oblique to the incident surface can be reduced. As a result, the amounts of a red component and/or a green component of light rays emitted from a region surrounding a region of the light-emitting surface of the fluorescent film located directly in front of the LED can be reduced, and therefore, the components of light rays emitted from the surrounding region can be changed to be closer to the components of light rays emitted from the region located directly in front of the LED. Therefore, color nonuniformity can be prevented or reduced on the light-emitting surface of the fluorescent film.

In the display apparatus of the present embodiment, the optical path changing member changes the optical paths of light rays emitted from the LED in a direction perpendicular to the incident surface so as to increase the optical path lengths of the light rays within the fluorescent film.

The optical path changing member changes the optical paths of light rays emitted from the LED in a direction perpendicular to the incident surface of the fluorescent film before the light rays enter the fluorescent film so as to increase the optical path lengths of the light within the fluorescent film. Specifically, the optical path lengths within the fluorescent film of light rays emitted from the LED in a direction perpendicular to the incident surface are changed to be closer to the optical path lengths within the fluorescent film of light rays emitted from the LED in a direction oblique to the incident surface. As a result, the amount of light rays that perpendicularly strikes the incident surface and then travels within the fluorescent film is reduced, and therefore, the amount of a blue component of light emitted from a region of the light-emitting surface of the fluorescent film located directly in front of the LED can be reduced.

In addition, the optical paths of light rays traveling in a direction perpendicular to the incident surface are changed so as to increase the optical path lengths within the fluorescent film of the light rays entering from the incident surface, and therefore, the conversion amount of the light within the fluorescent film is increased. As a result, the amounts of a red component and/or a green component of light emitted from a region surrounding a region of the light-emitting surface of the fluorescent film located directly in front of the LED can be increased. Therefore, color nonuniformity can be prevented or reduced on the light-emitting surface of the fluorescent film.

### REFERENCE SIGNS LIST

10 liquid crystal panel (display panel)
11, 14 polarizing plate
12 front substrate
13 rear substrate
20 optical member
30 backlight unit (light source unit)
31 chassis
32 substrate

### 33 LED

21 light condensing member
22 fluorescent film
23, 25 prism film (optical path changing member)
24 diffusion plate
26 microlens film (optical path changing member)
100 display apparatus

1.-6. (canceled)

7. A display apparatus, comprising:
a display panel;
a backlight device having a plurality of LEDs;
a fluorescent film having an incident surface and a light-emitting surface, the fluorescent film being provided between the backlight device and the display panel such that the light-emitting surface faces the display panel;
a diffusion member provided between the backlight device and the fluorescent film; and
an optical path changing member provided between the diffusion member and the fluorescent film, wherein
the optical path changing member is configured to receive light rays emitted from the backlight device and diffused by the diffusion member and to change optical paths of light rays travelling toward the incident surface of the fluorescent film so as to change optical path lengths of light rays traveling within the fluorescent film.

8. The display apparatus of claim 7, wherein
the optical path changing member is configured to change optical paths of light rays travelling toward the incident surface at different angles with respect to the incident surface so as to reduce differences in optical path lengths of light rays traveling within the fluorescent film.

9. The display apparatus of claim 7, wherein
the optical path changing member is configured to change an optical path of a light ray travelling perpendicularly to the incident surface or an optical path of a light ray travelling obliquely to the incident surface so as to reduce differences in optical path lengths of light rays traveling within the fluorescent film.

10. The display apparatus of claim 7, wherein
the optical path changing member is configured to reduce an optical path length of a light ray travelling obliquely to the incident surface.

11. The display apparatus of claim 7, wherein
the optical path changing member is configured to increase an optical path length of a light ray travelling perpendicularly to the incident surface.

12. The display apparatus of claim 7, wherein
the optical path changing member includes at least one selected from the group consisting of a prism film, a microlens film and a light diffusion sheet.

13. The display apparatus of claim 7, wherein
the fluorescent film includes a quantum dot film.
